(19) United States
(12) Patent Application Publication
(10) Pub. No.: US 2021/0224591 A1
(43) Pub. Date: Jul. 22, 2021

(54) METHODS AND SYSTEMS FOR TRAINING AN OBJECT DETECTION ALGORITHM

(71) Applicant: SEIKO EPSON CORPORATION, Tokyo (JP)

(72) Inventors: Dibyendu MUKHERJEE, Scarborough (CA); Syed Alimul HUDA, Scarborough (CA)

(73) Assignee: SEIKO EPSON CORPORATION, Tokyo (JP)

(21) Appl. No.: 16/746,171

(22) Filed: Jan. 17, 2020

(51) Int. Cl. G06K 9/62; G06T 7/73; G06K 9/00

(52) U.S. Cl. CPC G06K 9/6256; G06T 2207/20081; G06K 9/00624; G06T 7/74

(57) ABSTRACT

An exemplary method includes generating a first image containing a model image based on a 3D model at a pose. Second images are acquired containing an image not containing the model image. Training image patches are extracted from the first and second images, each training image patch being associated with a class representing whether the corresponding image patch contains at least a part of the model image. An algorithm model is trained with the training image patches and the respective classes to derive the model image's position relative to the first image. Parameters defining the trained algorithm model are stored.

Another exemplary method includes a camera acquiring an image containing an object in a scene. An enhancement filter is applied to the acquired image. Image patches are extracted from the filtered image. The object's position is determined in the image by applying the trained algorithm model to the image patches.

### BACKGROUND

### 1. Technical Field

The disclosure relates generally to the field of training object detection algorithms, and more specifically to methods and systems for training object detection algorithms and detecting objects with such object detection algorithms.

### 2. Related Art

Estimation of 6DoF (six degrees of freedom), or 3D (three-dimensional), poses of 3D objects from RGB (Red, Green, Blue) or RGB-D (RGB-depth) images has been a key element in robot manipulations, bin-picking, augmented reality applications, and various other challenging scenarios.

### SUMMARY

An advantage of some aspects of the disclosure is to solve at least a part of the problems described above, and aspects of the disclosure can be implemented as the following aspects.

One aspect of the disclosure is a non-transitory computer readable medium that embodies instructions that cause one or more processors to perform a method. The method includes: (a) generating a first image containing a model image based on a 3D model at a pose, the 3D model corresponding to an object, (b) acquiring second images containing an image that does not contain the model image, (c) extracting training image patches from the first image and the second images, each training image patch being associated with a class representing whether the corresponding image patch contains at least a part of the model image, (d) training an algorithm model with the training image patches and the respective classes so as to derive a position of the model image with respect to the first image, and(e) storing, in a memory, parameters defining the trained algorithm model.

A further aspect of this disclosure is a non-transitory computer readable medium that embodies instructions that cause one or more processors to perform a method. The method includes: (a) generating a domain-adapted image containing a model image based on a 3D model at a pose, the 3D model corresponding to an object, (b) extracting training image patches from the domain-adapted image, each training image patch being associated with a class representing whether the corresponding image patch contains at least a part of the model image, (c) training an algorithm model with the training image patches and the respective classes so as to derive a position of the model image with respect to the first image, and (d) storing, in a memory, parameters defining the trained algorithm model.

A further aspect of this disclosure is a non-transitory computer readable medium that embodies instructions that cause one or more processors to perform a method. The method includes: (a) acquiring, from a camera, an input image containing an object in a scene, (b) applying an enhancement filter to the acquired input image, (c) extracting image patches from the filtered input image, (d) determining a position of the object in the input image by applying a trained algorithm model to the image patches, wherein the trained algorithm model is trained with training image patches and respective classes so as to derive a position of a model image with respect to a first image, the model image being based on a 3D model at a pose, the 3D model corresponding to the object, and wherein the training image patches are extracted from the first image and second images, the first image containing the model image, the second images containing no model image.

A further aspect of this disclosure is a non-transitory computer readable medium that embodies instructions that cause one or more processors to perform a method. The method includes: (a) acquiring, from a camera, an input image containing an object in a scene, (b) applying an enhancement filter to the acquired input image, (c) extracting image patches from the filtered input image, (d) determining a position of the object in the input image by applying a trained algorithm model to the image patches, wherein the trained algorithm model is trained with training image patches and respective classes so as to derive a position of a model image with respect to a first image, the model image being based on a 3D model at a pose, the 3D model corresponding to the object, and wherein the training image patches are extracted from a domain-adapted image.

The skilled person will appreciate that except where mutually exclusive, a feature described in relation to any one of the above embodiments may be applied mutatis mutandis to any other embodiment.

### BRIEF DESCRIPTION OF THE DRAWINGS

The disclosure will be described with reference to the accompanying drawings, wherein like numbers reference like elements.

FIG. 1 is a diagram illustrating a schematic configuration of an example HMD.

FIG. 2 is a block diagram illustrating a functional configuration of the HMD shown in FIG. 1.

FIG. 3 is a block diagram illustrating a functional configuration of a computer for performing the methods of this disclosure.

FIG. 4 is a flow diagram of an example method according to this disclosure.

FIGS. 5A and 5B collectively is a flow diagram of an example method of performing step S416 of FIG. 4.

FIG. 6 is a flow diagram of an example method of detecting an object a using training data according to one embodiment.

FIG. 7 is a diagram showing detection of an object according to one embodiment.

FIG. 8 is a diagram showing detection of an object according to another embodiment.

### DESCRIPTION OF EXEMPLARY EMBODIMENTS

The disclosure relates generally to training object detection algorithms, and more specifically to methods and systems for training object detection algorithms using synthetic two-dimensional (2D) images.

In some embodiments, the trained object detection algorithm is used by an object detection device, such as an AR device. Some example systems include and/or interface with an AR device. In still other embodiments, the methods described herein for training an object detection algorithm are performed by the AR device itself.

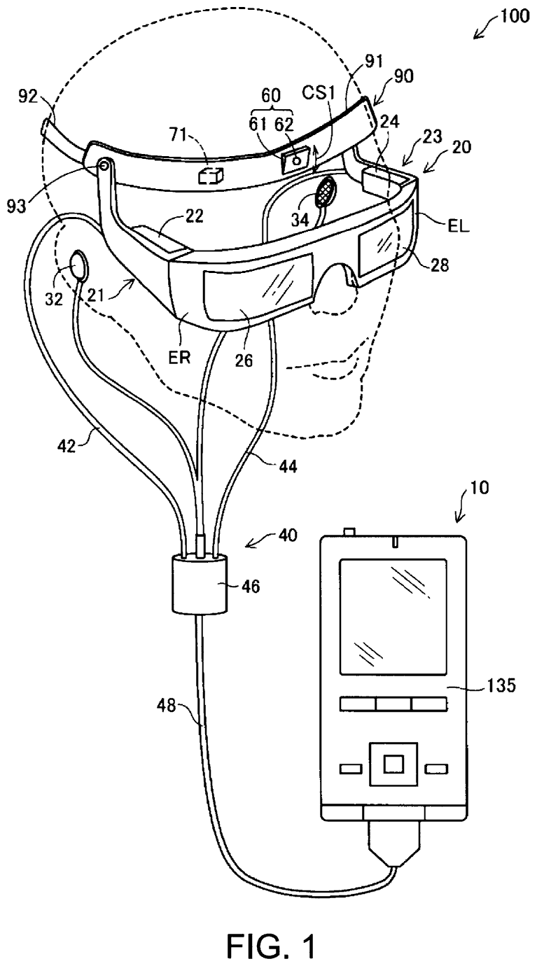

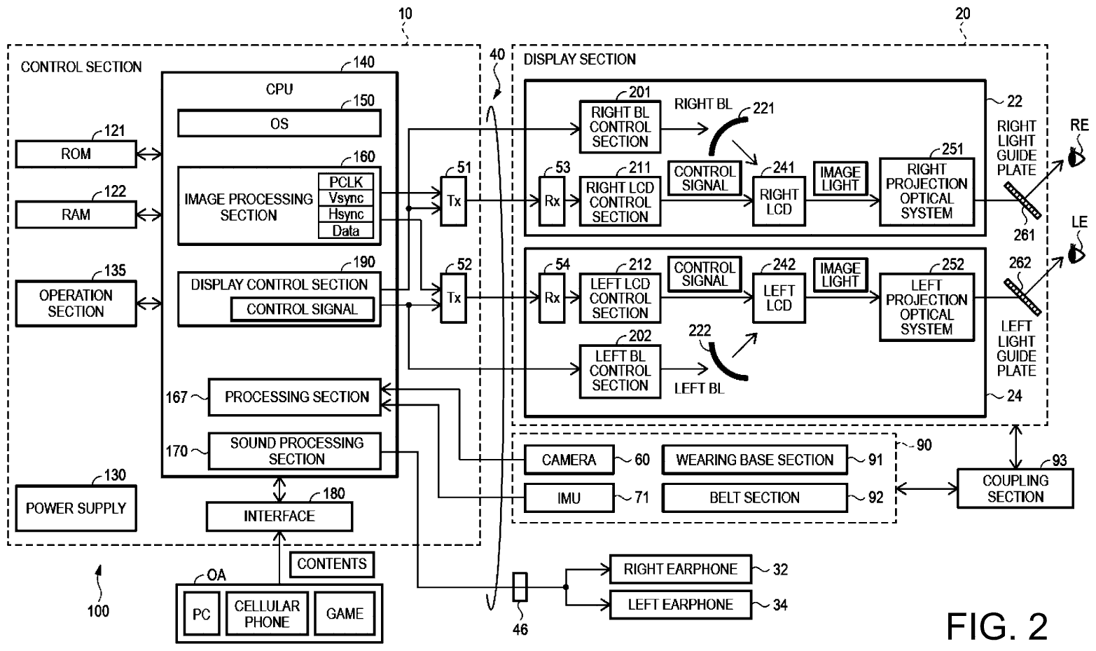

The AR device may be, for example, an HMD. An example HMD suitable for use with the methods and systems described herein will be described with reference to FIGS. 1 and 2.

FIG. 1 is a schematic configuration of an HMD 100. The HMD 100 is a head-mounted display device (a head mounted display). The HMD 100 is an optical transmission type. That is, the HMD 100 can cause a user to sense a virtual image and, at the same time, cause the user to directly visually recognize an outside scene.

The HMD 100 includes a wearing belt 90 wearable on the head of the user, a display section 20 that displays an image, and a control section 10 that controls the display section 20. The display section 20 causes the user to sense a virtual image in a state in which the display section 20 is worn on the head of the user. The display section 20 causing the user to sense the virtual image is referred to as “display AR” as well. The virtual image sensed by the user is referred to as AR image as well.

The wearing belt 90 includes a wearing base section 91 made of resin, a belt 92 made of cloth coupled to the wearing base section 91, a camera 60, and an IMU (Inertial Measurement Unit) 71. The wearing base section 91 has a shape curved along the form of the frontal region of a person's forehead. The belt 92 is worn around the head of the user.

The camera 60 functions as an imaging section. The camera 60 is capable of imaging an outside scene and disposed in a center portion of the wearing base section 91. In other words, the camera 60 is disposed in a position corresponding to the center of the forehead of the user in a state in which the wearing belt 90 is worn on the head of the user. Therefore, the camera 60 images an outside scene, which is a real scene on the outside in a line of sight direction of the user, and acquires a captured image, which is an image captured by the camera 60, in the state in which the user wears the wearing belt 90 on the head.

The camera 60 includes a camera base section 61 that rotates with respect to the wearing base section 91 and a lens section 62, a relative position of which is fixed with respect to the camera base section 61. The camera base section 61 is disposed to be capable of rotating along an arrow CS1, which indicates a predetermined range of an axis included in a plane including the center axis of the user, when the wearing belt 90 is worn on the head of the user. Therefore, the direction of the optical axis of the lens section 62, which is the optical axis of the camera 60, can be changed in the range of the arrow CS1. The lens section 62 images a range that changes according to zooming centering on the optical axis.

The IMU 71 is an inertial sensor that detects acceleration. The IMU 71 can detect angular velocity and terrestrial magnetism in addition to the acceleration. The IMU 71 is incorporated in the wearing base section 91. Therefore, the IMU 71 detects acceleration, angular velocity, and terrestrial magnetism of the wearing belt 90 and the camera base section 61.

A relative position of the IMU 71 to the wearing base section 91 is fixed. Therefore, the camera 60 is movable with respect to the IMU 71. Further, a relative position of the display section 20 to the wearing base section 91 is fixed. Therefore, a relative position of the camera 60 to the display section 20 is movable.

The display section 20 is coupled to the wearing base section 91 of the wearing belt 90. The display section 20 is an eyeglass type. The display section 20 includes a right holding section 21, a right display driving section 22, a left holding section 23, a left display driving section 24, a right optical-image display section 26, and a left optical-image display section 28.

The right optical-image display section 26 and the left optical-image display section 28 are located in front of the right eye and the left eye of the user when the user wears the display section 20. One end of the right optical-image display section 26 and one end of the left optical-image display section 28 are connected to each other in a position corresponding to the middle of the forehead of the user when the user wears the display section 20.

The right holding section 21 has a shape extending in a substantial horizontal direction from an end portion ER, which is the other end of the right optical-image display section 26, and inclining obliquely upward halfway. The right holding section 21 connects the end portion ER and a coupling section 93 on the right side of the wearing base section 91.

Similarly, the left holding section 23 has a shape extending in a substantial horizontal direction from an end portion EL, which is the other end of the left optical-image display section 28 and inclining obliquely upward halfway. The left holding section 23 connects the end portion EL and a coupling section (not shown in the figure) on the left side of the wearing base section 91.

The right holding section 21 and the left holding section 23 are coupled to the wearing base section 91 by left and right coupling sections 93 to locate the right optical-image display section 26 and the left optical-image display section 28 in front of the eyes of the user. Note that the coupling sections 93 couple the right holding section 21 and the left holding section 23 to be capable of rotating and capable of being fixed in any rotating positions. As a result, the display section 20 is provided to be capable of rotating with respect to the wearing base section 91.

The right holding section 21 is a member provided to extend from the end portion ER, which is the other end of the right optical-image display section 26, to a position corresponding to the temporal region of the user when the user wears the display section 20.

Similarly, the left holding section 23 is a member provided to extend from the end portion EL, which is the other end of the left optical-image display section 28 to a position corresponding to the temporal region of the user when the user wears the display section 20. The right display driving section 22 and the left display driving section 24 are disposed on a side opposed to the head of the user when the user wears the display section 20.

The display driving sections 22 and 24 include liquid crystal displays 241 and 242 (hereinafter referred to as “LCDs 241 and 242” as well) and projection optical systems 251 and 252 explained below. The configuration of the display driving sections 22 and 24 is explained in detail below.

The optical-image display sections 26 and 28 include light guide plates 261 and 262 and dimming plates explained below. The light guide plates 261 and 262 are formed of a light transmissive resin material or the like and guide image lights output from the display driving sections 22 and 24 to the eyes of the user.

The dimming plates are thin plate-like optical elements and are disposed to cover the front side of the display section 20 on the opposite side of the side of the eyes of the user. By adjusting the light transmittance of the dimming plates, it is possible to adjust an external light amount entering the eyes of the user and adjust visibility of a virtual image.

The display section 20 further includes a connecting section 40 for connecting the display section 20 to the control section 10. The connecting section 40 includes a main body cord 48 connected to the control section 10, a right cord 42, a left cord 44, and a coupling member 46.

The right cord 42 and the left cord 44 are two cords branching from the main body cord 48. The display section 20 and the control section 10 execute transmission of various signals via the connecting section 40. As the right cord 42, the left cord 44, and the main body cord 48, for example, a metal cable or an optical fiber can be adopted.

The control section 10 is a device for controlling the HMD 100. The control section 10 includes an operation section 135 including an electrostatic track pad and a plurality of buttons that can be pressed. The operation section 135 is disposed on the surface of the control section 10.

FIG. 2 is a block diagram functionally showing the configuration of the HMD 100. As shown in FIG. 2, the control section 10 includes a ROM 121, a RAM 122, a power supply 130, the operation section 135, a CPU 140 (sometimes also referred to herein as processor 140), an interface 180, and a transmitting section 51 (Tx 51) and a transmitting section 52 (Tx 52).

The power supply 130 supplies electric power to the sections of the HMD 100. Various computer programs are stored in the ROM 121. The CPU 140 develops or loads, in the RAM 122, the computer programs stored in the ROM 121 to execute the computer programs. The computer programs include computer programs for realizing tracking processing and AR display processing explained below.

The CPU 140 develops, in the RAM 122, the computer programs stored in the ROM 121 to function as an operating system 150 (OS 150), a display control section 190, a sound processing section 170, an image processing section 160, and a processing section 167.

The display control section 190 generates control signals for controlling the right display driving section 22 and the left display driving section 24. The display control section 190 controls generation and emission of image lights respectively by the right display driving section 22 and the left display driving section 24.

The display control section 190 transmits control signals to a right LCD control section 211 and a left LCD control section 212 respectively via the transmitting sections 51 and 52. The display control section 190 transmits control signals respectively to a right backlight control section 201 and a left backlight control section 202.

The image processing section 160 acquires an image signal included in contents and transmits the acquired image signal to receiving sections 53 and 54 of the display section via the transmitting sections 51 and 52. The sound processing section 170 acquires a sound signal included in the contents, amplifies the acquired sound signal, and supplies the sound signal to a speaker (not shown in the figure) in a right earphone 32 and a speaker (not shown in the figure) in a left earphone 34 connected to the coupling member 46.

The processing section 167 acquires a captured image from the camera 60 in association with time. The time in this embodiment may or may not be based on a standard time. The processing section 167 calculates a pose of an object (a real object) according to, for example, a transformation matrix. The pose of the object means a spatial relation (a rotational and a translational relation) between the camera 60 and the object. The processing section 167 calculates, using the calculated spatial relation and detection values of acceleration and the like detected by the IMU 71, a transformation matrix for converting a coordinate system fixed to the camera 60 to a coordinate system fixed to the IMU 71. The function of the processing section 167 is used for the tracking processing and the AR display processing explained below.

The interface 180 is an input/output interface for connecting various external devices OA, which are supply sources of contents, to the control section 10. Examples of the external devices OA include a storage device having stored therein an AR scenario, a personal computer (Pc), a cellular phone terminal, and a game terminal. As the interface 180, for example, a USB interface, a micro USB interface, and an interface for a memory card can be used.

The display section 20 includes the right display driving section 22, the left display driving section 24, the right light guide plate 261 functioning as the right optical-image display section 26, and the left light guide plate 262 functioning as the left optical-image display section 28. The right and left light guide plates 261 and 262 are optical see-through elements that transmit light from real scene.

The right display driving section 22 includes the receiving section 53 (Rx53), the right backlight control section 201 and a right backlight 221, the right LCD control section 211 and the right LCD 241, and the right projection optical system 251. The right backlight control section 201 and the right backlight 221 function as a light source.

The right LCD control section 211 and the right LCD 241 function as a display element. The display elements and the optical see-through elements described above allow the user to visually perceive an AR image that is displayed by the display elements to be superimposed on the real scene. Note that, in other embodiments, instead of the configuration explained above, the right display driving section 22 may include a self-emitting display element such as an organic EL display element or may include a scan-type display element that scans a light beam from a laser diode on a retina. The same applies to the left display driving section 24.

The receiving section 53 functions as a receiver for serial transmission between the control section 10 and the display section 20. The right backlight control section 201 drives the right backlight 221 on the basis of an input control signal. The right backlight 221 is a light emitting body such as an LED or an electroluminescence (EL) element. The right LCD control section 211 drives the right LCD 241 on the basis of control signals transmitted from the image processing section 160 and the display control section 190. The right LCD 241 is a transmission-type liquid crystal panel on which a plurality of pixels is arranged in a matrix shape.

The right projection optical system 251 is configured by a collimate lens that converts image light emitted from the right LCD 241 into light beams in a parallel state. The right light guide plate 261 functioning as the right optical-image display section 26 guides the image light output from the right projection optical system 251 to the right eye RE of the user while reflecting the image light along a predetermined optical path. Note that the left display driving section 24 has a configuration same as the configuration of the right display driving section 22 and corresponds to the left eye LE of the user. Therefore, explanation of the left display driving section 24 is omitted.

The device to which the technology disclosed as an embodiment is applied may be an imaging device other than an HMD. For example, the device may be an imaging device that has no function of displaying an image.

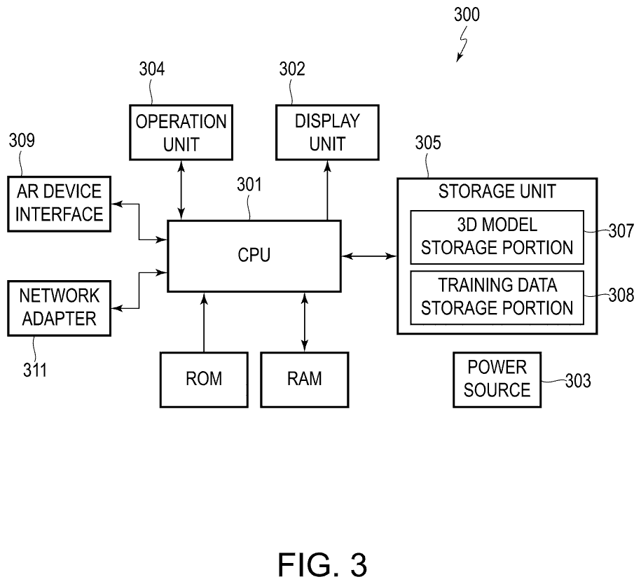

FIG. 3 is a block diagram illustrating a functional configuration of a computer 300 as an information processing device in the present embodiment which performs the methods described herein. The computer 300 includes a CPU 301, a display unit 302, a power source 303, an operation unit 304, a storage unit 305, a ROM, a RAM, an AR interface 309 and a network adaptor 310. The power source 303 supplies power to each unit of the computer 300. The operation unit 304 is a user interface (GUI) for receiving an operation from a user. The operation unit 304 includes a keyboard, a mouse and a touch pad and the like and their driver software.

The storage unit 305 stores various items of data and computer programs, and includes a hard disk drive, a solid-state drive, or the like. The storage unit 305 includes a 3D model storage portion 307 and a template storage portion 308. The 3D model storage portion 307 stores a three-dimensional model of a target object, created by using computer-aided design (CAD) or other 3D reconstruction methods. The training data storage portion 308 stores training data created as described herein (not shown). The storage unit 305 also stores instructions (not shown) for execution by the CPU 301. The instructions cause the CPU 301 to perform the methods described herein. The AR interface 309 is an interface for communicative connection to an AR device. The AR interface may be any wired or wireless interface suitable for establishing a data connection for communication between the computer 300 and an AR device. The AR interface may be, for example, a Wi-Fi transceiver, a USB port, a Bluetooth® transceiver, a serial communication port, a proprietary communication port, or the like. The network adaptor 310 is configured to allow CPU 301 to connect to one or more networks to communicate with other computers, such as a server computer via a wireless network, so that, for example, the computer 300 receives from the other computer a computer program that causes the computer 300 to perform functions described in the embodiments described herein. In some embodiments, the AR device interface 309 and the network adaptor 310 are a single adaptor suitable for performing the tasks of both network adaptor 310 and AR device interface 309.

By way of AR device interface 309, the CPU 301 communicates with camera 60 (shown in FIGS. 1 and 2). The camera 60 is an RGB image sensor and/or an RGBD sensor and used when the CPU 301 acquires an image including a 2.5D image or a video/2.5D video sequence of a real object. The network adapter 311 is configured to allow CPU 301 to communicate with another computer such as a server computer via a wireless network, so that, for example, the computer 300 receives from the other computer a program that causes the computer 300 to perform functions described in this embodiment.

The CPU 301 reads various programs (also sometimes referred to herein as instructions) from the ROM and/or the storage unit 305 and develops the programs in the RAM, so as to execute the various programs. Suitable instructions are stored in storage unit 305 and/or the ROM and executed by the CPU 301 to cause the computer 300 to operate as a training computer to train the object detection algorithm as described herein. In some embodiments, the computer 300, with the appropriate programming, is a system for training an object detection algorithm using synthetic images. In other embodiments, the HMD 100 is the system for training an object detection algorithm using synthetic images. In still other embodiments, the system for training an object detection algorithm using synthetic images includes the computer 300 and the HMD 100.

The embodiments described herein relate to methods and systems for training an object detection algorithm using synthetic images, rather than actual images of a real-world object. As used herein, synthetic images generally refer to 2D images that are not created using a camera to capture a representation of a 3D scene. More specifically, with respect to training an object detection algorithm to detect a representation of a real-world 3D object in image frames captured by a camera, synthetic images are 2D images that are not created by a camera capturing a representation of the real-world 3D object. Synthetic images may be generated by capturing 2D images of a 3D model of an object in a computer (e.g., a 3D CAD model of an object), drawing (whether by hand or using a computer) a 2D image of the object, or the like. It should be noted that synthetic images include images of a synthetic image. For example, a photograph or scan of a synthetic image may itself be a synthetic image, in one embodiment. Conversely, images of an actual image, such as a photograph or scan of a photograph of the real-world 3D image, may not be synthetic images for purposes of this disclosure under one embodiment.

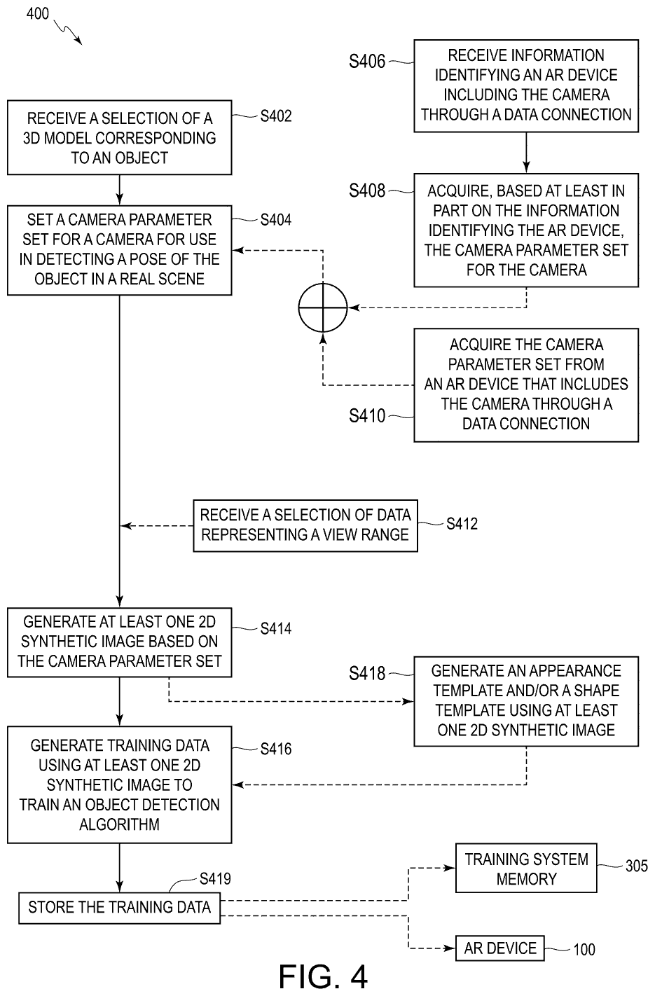

FIG. 4 is a flow diagram of an example method 400 of training an object detection algorithm using synthetic images. The method 400 may be performed by computer 300 to train an object detection algorithm for use with the HMD 100 and will be described with reference to computer 300 and HMD 100. In other embodiments, the method 400 may be performed by a different computer (including, e.g., the control section 10), may be used to train an object detection algorithm for a different AR device, may be used to, and/or may be used to train an object detection algorithm for any other device that performs object detection based on image frames. To facilitate performance by a computer, the method 400 is embodied as instructions executable by one or more processors and stored in a non-transitory computer readable medium.

Initially, in S402, CPU 301 receives a selection of a 3D model stored in one or more memories, such as the ROM or the storage unit 305. The 3D model may correspond to a real-world object that the object detection algorithm is to be trained to detect in 2D image frames. In the example embodiment, the selection is received from a user, such as by a user selection through a GUI of the computer 300.

It is noted that a 3D model is discussed herein as being used to generate synthetic images in method 400. However, in some embodiments, a 3D model may not be required and instead, electronic data other than a 3D model (e.g., a 2D model, one or more 2D or 3D synthetic images, or the like) may be used in step S402. As such, for ease of description, the steps of method 400 (and other parts of the present disclosure) are described using a 3D model. However, the present disclosure is not limited to using a 3D model under step S402 and anywhere where a 3D model is referenced, it should be understood that some embodiments may relate to using electronic data other than a 3D model.

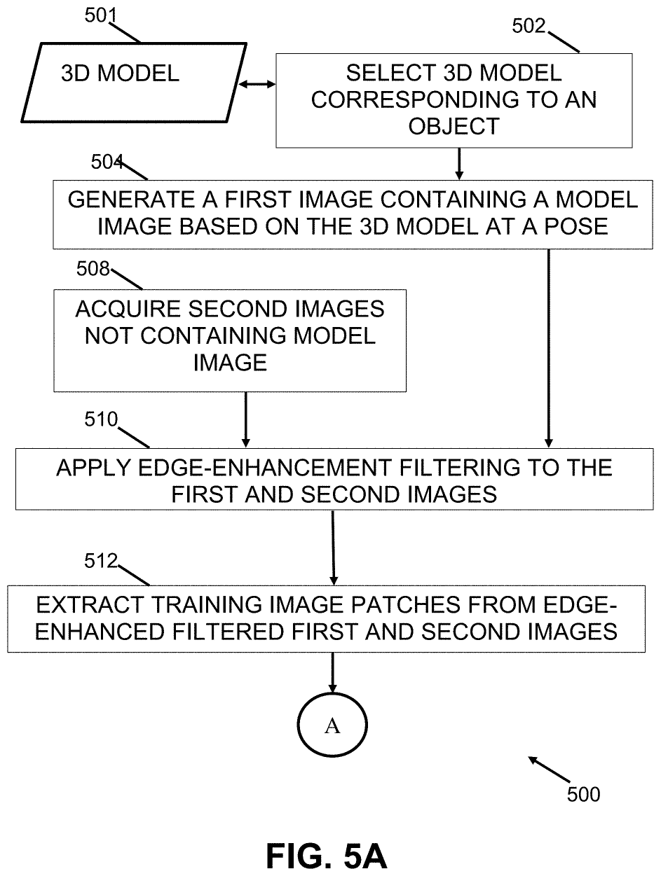

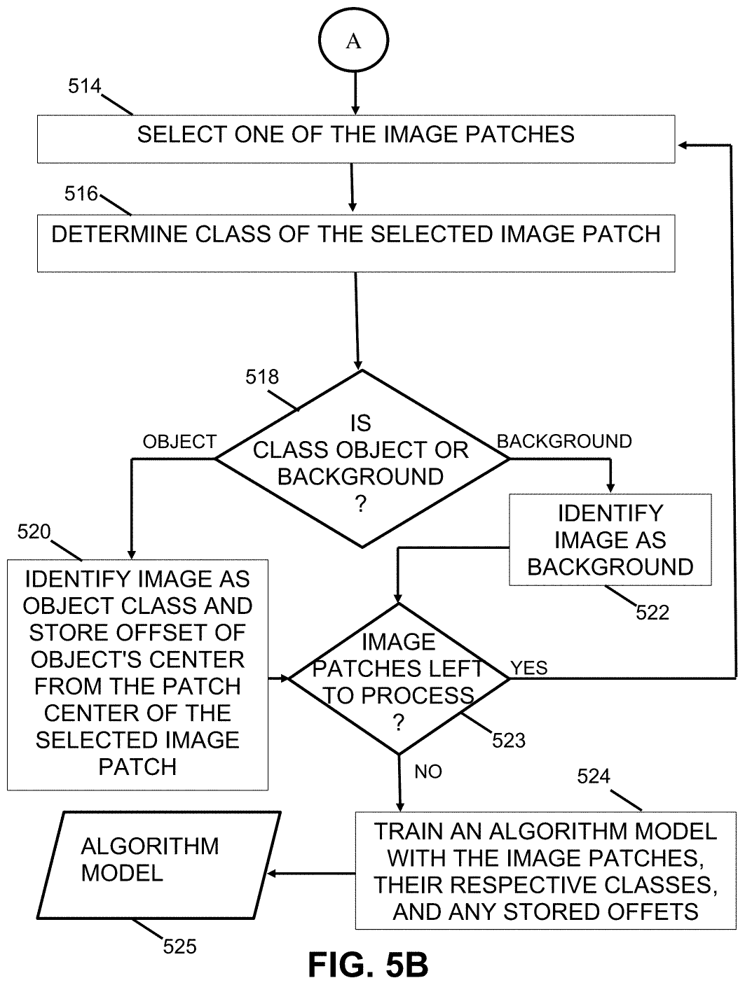

A camera parameter set for a camera, such as the camera 60, for use in detecting a pose of the object in a real scene is set in S404. The images captured by different cameras of the same real scene will typically differ at least somewhat based on the particular construction and components of each camera. The camera parameter set defines, at least in part, how its associated camera will capture an image. In the example embodiment, the camera parameter set may include the resolution of the images to be captured by the camera and camera intrinsic properties (or “camera intrinsics”), such as the X and Y direction focal lengths (fx and fy, respectively), and the camera principal points coordinates (cx and cy). Other embodiments may use additional or alternative parameters for the camera parameter set. In some embodiments, the camera parameter set is set by the user, such as by a user selection through a graphical user interface (“GUI”) of the computer 300 (as is discussed later with regard to FIG. 5).

In some embodiments, the camera parameter set is set by the computer 300 without being selected by the user. In some embodiments, a default camera parameter set is set by the computer 300. The default camera parameter set maybe used when the camera that will be used in detecting the pose of the object in the real scene is unknown or its parameters are unknown. The default camera set may include the parameters for an ideal camera, a popular camera, a last camera for which a camera parameter set was selected, or any other suitable camera parameter set. Moreover, some embodiments provide a combination of one or more of the above-described methods of setting the camera parameter set.

According to various embodiments, the camera parameter set (S404) can be set by many different ways, including by a computer retrieving a pre-stored model from a plurality of models pre-stored on a database, the computer receiving camera parameters from a connected AR device, and/or by a user directly entering (and/or modifying) into a GUI. However, the present application should not be limited to these specific embodiments. Nonetheless, the above embodiments are described herein below.

First, in some embodiments, setting the camera parameter set (S404) is performed by receiving information identifying a known AR device including the camera (S406). The information identifying the AR device is received from a user input, such as by selecting, through the computer's GUI, the AR device from a list of known AR devices. In other embodiments, the user may input the information identifying the AR device, such as by typing in a model name, model number, serial number, or the like.

The CPU 301 acquires, based at least in part on the information identifying the AR device, the camera parameter set for the camera (S408). The camera parameter set may be acquired from a plurality of the camera parameter sets stored in one or more memories, such as the storage unit 305 or a local or remote database. Each camera parameter set is associated in the one or more memories with at least one AR device of a plurality of different AR devices. Because multiple different AR devices may include the same camera, a single camera parameter set may be associated with multiple AR devices.

In some embodiments, setting the camera parameter in S404 includes acquiring the camera parameter set from AR device that includes the camera through a data connection when the AR device becomes accessible by the one or more processors (S410). For example, when the HMD 100 is connected (wired or wirelessly) to the AR device interface 309 of the computer 300, the CPU 301 may retrieve the camera parameter set from HMD 100 (stored, for example, in the ROM 121). In other embodiments, the computer 300 may acquire the camera parameter set from the AR device by determining the camera parameter set. For example, the computer 300 may cause the camera 60 in the HMD 100 to capture one or more image frames of, for example, a calibration sheet and the computer 300 may analyze the resulting image frame(s) to determine the camera parameter set. In still other embodiments, the computer 300 may retrieve from the AR device an identification of the AR device and/or the camera in the AR device and retrieve the appropriate camera parameter set from the one or more memories based on the retrieved identification. As mentioned above, the various techniques may be combined. For example, in some embodiments, if the AR device is available to the computer (e.g., it is connected to AR device interface 309) , the camera parameter set is acquired from the camera, and if the AR device is not available to the computer the setting of S406 and S408 is performed.

Once the camera parameter set is set, the CPU 301 generates at least one 2D synthetic image based on the camera parameter set by rendering, or projecting, the 3D model in a view range (S414). The view range is the range of potential locations of the camera 60 around the stationary object for which images will be synthesized. In the example embodiment, the view range includes an azimuth component and an elevation component. The view range may also include a distance component that sets a distance of the potential locations in the view range from the 3D model of the object. The view range generally defines an area on the surface of a sphere having a radius equal to the length of the distance component. Each view point within the view range for which a synthetic image is generated represents a different pose of the object.

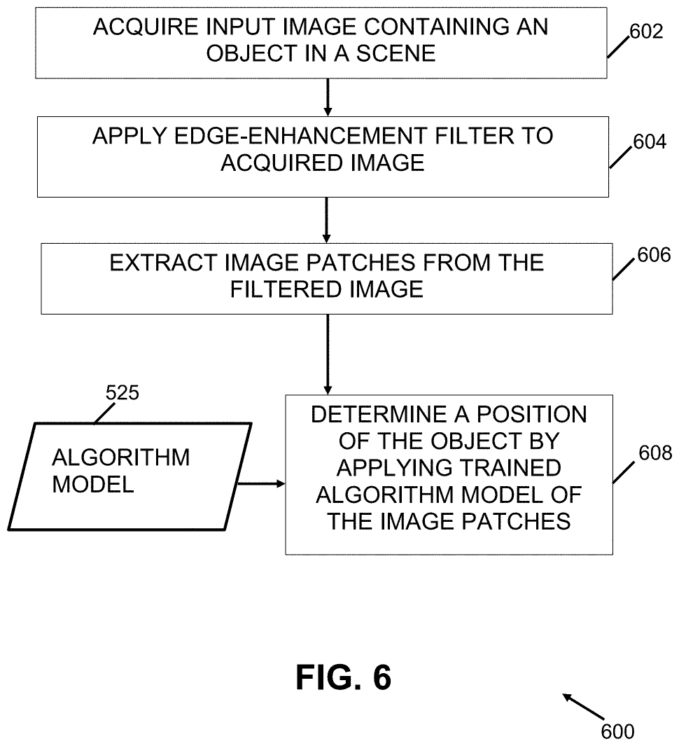

In some embodiments, the CPU 301 receives selection of data representing the view range (S412) before generating the at least one 2D synthetic image. The selection may be received, for example, from a user selection via a GUI, such as the GUI shown and discussed later for FIG. 5. In some embodiments, the GUI includes a preview view of the object and a graphical representation of the user selected view range. In some embodiments, the view range is a single pose of the object selected by the user. In other embodiments, the view range is a predetermined (e.g., a default) view range. In still other embodiments, the CPU 301 utilizes the predetermined view range unless the user provides a different selection of the view range (or modification of the predetermined view range. In some embodiments the predetermined view range is less than 360 degrees around the object in one or more of the azimuth or elevation. The view range will be explained in more detail below with reference to FIGS. 5 and 6.

The CPU 301 generates at least one 2D synthetic image of the 3D model representing the view of the 3D model from a location within the view range. The number of 2D synthetic images to be generated may be fixed, variable, or user selectable. Any suitable number of images may be generated as long as at least one 2D synthetic image is generated. If a single 2D synthetic image is generated, the image is generated for a central point within the view range. If more than one image is generated, the images are generated relatively evenly throughout the view range. In some embodiments, if the number of views is fixed or set by the user, the computer 300 determines how far apart within the view range to separate each image to achieve some distribution of images within the view range such as an even distribution (e.g., so that each image is a view from a same distance away from the view of each adjacent image). In other embodiments, the computer 300 generates a variable number of images, based on the size of the view range and a fixed interval for the images. For example, the computer may generate an image from a viewpoint every degree, every five degrees, every ten degrees, every twenty degrees in azimuth and elevation within the view range. The intervals above are examples and any other suitable interval, including less than a full degree interval, may be used. The interval between images does not need to be the same for azimuth and elevation.

The computer 300 generates the at least one 2D synthetic image based on the camera parameter set that was set in S404. The camera parameter set alters the projection, or the rendering of the 3D object for the view point of the image to replicate a real image of the real-world object taken from the same viewpoint. In this embodiment, a process of generating synthetic images uses a rigid body transformation matrix for transforming 3D coordinate values of 3D points represented in the 3D model coordinate system to ones represented in an imaginary camera coordinate system, and a perspective projection transformation matrix for projecting the transformed 3D coordinate values to 2D coordinate values on the virtual plane of the synthetic images. The rigid body transformation matrix corresponds to a viewpoint, or simply a view, and is expressed by a rotation matrix representing rotations around three axes which are orthogonal to each other, and a translation vector representing translations along the three axes. The perspective projection transformation matrix includes camera parameters, and is appropriately adjusted so that the virtual plane corresponds to an imaging surface of a camera, such as camera 60. The 3D model may be a CAD model. For each view, or pose, the computer 300 transforms and projects 3D points on the 3D model to 2D points on the virtual plane so that a synthetic image is generated, by applying rigid body transformation and perspective projection transformation to the 3D points.

In S416, the computer 300 generates training data using the at least one 2D synthetic image to train an object detection algorithm. The training data based on the synthetic image may be generated using any technique suitable for use with real images. In some embodiments, generating the training data includes generating an appearance template and/or a shape template using the 2D synthetic image (S418). The appearance template includes one or more features such as color, surface images or text, corners, and the like. The appearance template may include, for example, coordinate values of the locations of features of the object in the 2D synthetic image and their characterization, the coordinates of locations on the 3D model that correspond to those 2D locations, and the 3D model in the pose for which the 2D image was generated. The shape template describes the shape of the object in two dimensions without the surface features that are included in the appearance template. The shape template may include, for example, coordinate values of points (2D contour points) included in a contour line (hereinafter, also simply referred to as a “contour”) representing an exterior of the object in the 2D synthetic image, the points on the 3D model that correspond to the 2D contour points, and the 3D model in the pose for which the 2D image was generated. In some embodiments, separate shape and appearance templates are created for each synthetic image generated for the view range. In other embodiments, data for multiple images may be stored in a single template.

The generated training data is stored in one or more memories (S419). In some embodiments, the training data is stored in the computer's training system memory 305. In some embodiments, when the HMD 100 is communicatively coupled to the computer 300 through the AR device interface 309, the training data is stored by the computer 300 in the memory (such as ROM 121) of the HMD 100. In other embodiments, the training data is stored in the computer's training system memory 305 and the HMD 100.

After the training data is stored in the HMD 100, the HMD 100 may operate to detect the object based on the training data. In some embodiments, the HMD attempts to detect the object in image frames of a real scene captured by the camera 60 by attempting to find a match between the template(s) and the image using the HMD's object detection algorithm.

In some embodiments, training data is generated for multiple cameras and/or AR devices for use in detecting a pose of the object in a real scene. In some such embodiments, setting the camera parameter set in S404 includes setting a plurality of camera parameter sets for a plurality of cameras, S414 includes generating a plurality of 2D synthetic images based at least on the plurality of camera parameter sets, and S416 includes generating training data using the plurality of 2D synthetic images to train an object detection algorithm for a plurality of AR devices having the plurality of cameras. In other embodiments, steps S404, S414, and S416 (optionally including one or more of S406, S408, S410, S412, and S418) are simply repeated multiple times, each time for a different camera.

Training Data Generation

In particular, the methods herein can generate object recognition training data using a 3D model (e.g., CAD model) instead of typical RGB images of the object. The use of RGB images of the object might be difficult to implement and can lower the quality of the training data, because the RGB textures will often be different during the detection phase. The CAD model is typically textureless, and the textureless CAD model of the object looks significantly different from the object, when captured using an RGB camera. This is due to the CAD model having only depth-based information, while the captured RGB images contain the textural information and there is a large mismatch of information between training and testing data. This mismatch increases the probability of false detections while significantly reducing detection performance.

The following provides various embodiments to solve the above-described issued. Generally, CAD models contains some depth and surface normal discontinuities that generate depth based edges, and these edges are visible to some extent in different lighting conditions when images are captured using an RGB camera. While some of these edges may be absent due to unfavorable lighting directions, or cluttered with additional edges generated from texture information, some parts of the object surface should still contain necessary depth-based edge information to differentiate the object from the background. Due to this edge information being localized to finite object patches, these patches can collectively provide information about the object in comparison to discrete background patches. In this regard, a clustering algorithm or other framework like entangled random forest can be used on extracted patches from edge-enhanced images to separate them into foreground (object) and background, vote on each foreground patch to determine object's center while discriminating object from background. Object patches generally vote for the object collectively, and accumulated votes can provide object location to be used for pose refinement. The below description (in combination with FIGS. 5-8) provide more detailed description of the various embodiments briefly described above.

FIG. 5A is a flow diagram of an example method of performing step S416 of FIG. 4. According to this method, training data can be developed using a three-dimensional (3D) model 501 which may be the stored in 3D model storage portion 307). An object detection algorithm model 525 is to be trained with the synthetic training data according to this example.

In step 502, the 3D model of the object is selected to generate training data. This 3D model may be a CAD model of an object that is expected to be detected in the real-world in the detection phase. For example, this could be an interactive object for AR software, or a manufacturing part that will be viewed and worked on by a robot. In one embodiment, the synthetic training data contains domain-adapted images corresponding to, or distributed in, a 360-degree view range in azimuth around the 3D model. For example, there may be at least one domain-adapted image in each 90-degree subrange of that 360-degree view range, or at least one domain-adapted image in each 180-degree subrange of that 360-degree range. In another embodiment, the view range may be restricted to less than 360 degrees, such as equal to or greater than 0 degree and equal to or less than 180 degrees in azimuth.

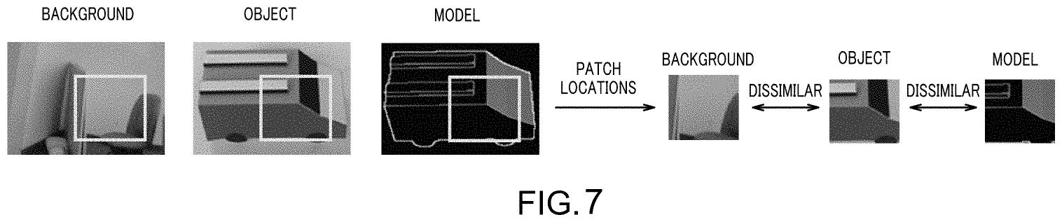

In step 504, a first image is generated containing a model image based on the 3D model at a view, or a pose, in three-dimensional coordinate system of the camera or the rendering camera. In this regard, the first image shows an image of the 3D model. For example, as shown in FIG. 7, the 3D model is a truck and the first image is an elevated perspective view of the truck from a front-side view of the truck. Because the truck is in the image and because the truck is the object in this example, the first image contains the model image at a pose. A “model image” may be referred to as a “2D model” or a “projected 3D model”. As used herein, when an image contains the object or the 3D model corresponding the object, this is referred to as an “object” or a “foreground” class or “object” image as opposed to when the image does not contain any object, being referred to herein as a “background” class or “background” image.

In step 508, one or more second images is acquired. Each of the second images contains an image that does not contain the model image, and thus each of the second images is a background image. In this regards, each of the second images are images that do not include an image of the object and only contains background images.

The first images and/or second images may be generated using the 3D model and/or using an RGB camera, and the present application should not be limiting in this regard.

In step 510, an enhancement filter is applied to the first and second images. In one embodiment, the enhancement filter is a feature-enhancement filter such as an edge-enhancement filter as shown in step 510 in FIG. 5A. A Laplacian filter and/or a LOG (Laplacian of Gauss) filter may be employed as the edged-enhancement filter. The edge-enhancement filter may be processing of the image for enhancing the contrast and improving the visibility of the lines in the image as well as removing texture in the image. For example, the edge correction processing can be processing to make the white areas and grey areas a monotone black and the previously black areas become white (since all other colors are becoming black). An effect of the edge enhancement processing is to make edges more clearly recognizable relative to an image that has texture or areas which have low contrast. In some embodiments, the enhancement filter may include more composite operations. For example, it may include representation of the edges using the edge orientations, magnitudes, and/or combinations of these measures along with other visual cues that enhance the foreground images.

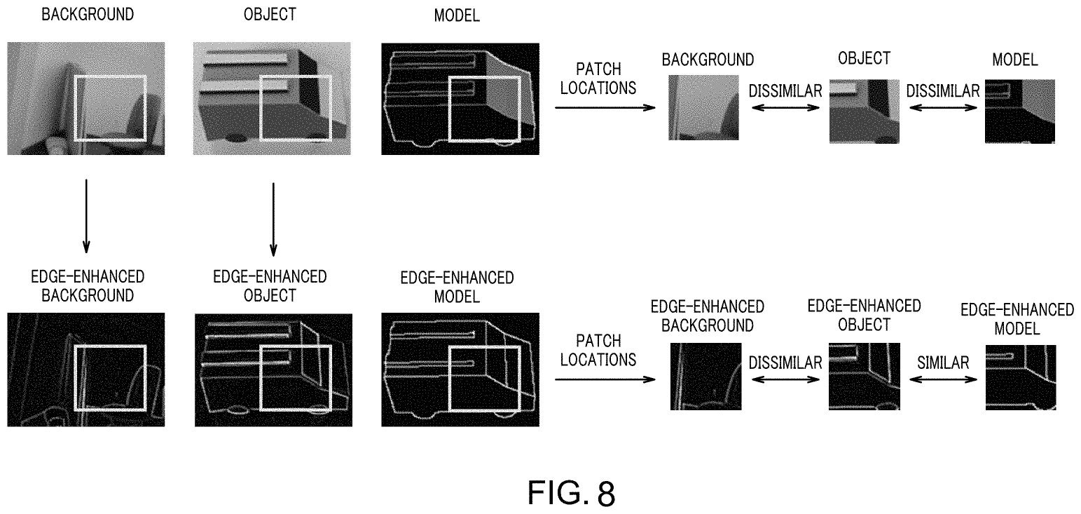

Once the enhancement process has been completed on the images, the images can then be compared much easier to determine if there is a match between the images. This is shown in FIGS. 7 and 8. In FIG. 7, there is a background image and an object (foreground) image which each have relatively low contrast relative to an image from the 3D model. In this regard, it is more difficult for a computer to recognize that two images are of the same object at the same pose but simply have different contrasts.

However, as shown in FIG. 8, when edge enhancement filter has been applied to the background image, object image, and the 3D model image, a computer can more easily detect two images are similar because the lines are similar due to high contrast in the images. As shown in FIG. 7, the background image, object image and model image are all determined to be dissimilar to each other to a computer because there are different textures and contrasts. However, after edge-enhancement, as shown in FIG. 8, while the edge-enhanced background image is dissimilar to the edge-enhanced object, the edge-enhanced object is similar to the edge-enhanced model image. As such, edge-enhancement simplifies images to black and white thereby emphasizing the edges of the images so as to allow the computer to more easily compare edge features.

In step 512, training image patches are extracted from the first image and the second images by only sampling a portion of the first and second images. This is shown in FIG. 8 whereby exemplary patches are the portions within the box on the background, object and model images, respectively.

Each training image patch is associated with a class representing whether the corresponding image patch contains at least a part of the model image, and thereby is either classified as either background class or object class.

For example, a first image will be an object class if it contains a part of the object. In other words, the first image contains an image portion corresponding to at least a portion of the object. For example, as shown in FIG. 7, the object may be a truck and a portion of the truck may be the windshield of the truck. In the regard, this exemplary first image may show only the windshield of the truck and thus, the first image is classified as an object class.

After extraction of the patches in the first and second images, each patch is selected individually and the class of that selected patch is then determined in steps 516 and 518.

To learn the classification between the patches of background and object, common structure present in the object is clustered together in a supervised way, while discriminating these structures against common background structures. For example, using the 3D model and the selected patch, an entangled random forest can be used on extracted patches from edge-enhanced images to separate them into foreground (object) and background classes.

If the method determines that the patch is an object class in step 520, then the patch is identified as object class and the system stores the object's center from the patch center of the image patch. Alternatively, if the method determines that the patch is background class in step 522, then the patch is identified as a background class patch.

Then, in step 523, the method will continue with steps 514 to 520/522 until all patches have been processed. After all patches have been processes, the algorithm model 525 will be trained with these patches, their respective assigned classes, and assigned offsets for all object class patches. At the end of training, each leaf node in the decision trees belonging to the random forest has a probability distribution of its likeliness of being object class or background class. The leaves also store the offsets to the object center from the patch centers, for the object patches that locate themselves in the corresponding leaf during the training. As a result, the trained algorithm model 525 is allowed to derive a position (e.g., center) of the model image with respect to the first image. These parameters defining the trained algorithm model are all stored in memory.

As mentioned above, the images generated in step 504 may be domain-adapted images representing the 3D model at corresponding poses. “Domain-adapted” herein can be defined as a state where a data distribution difference between the domains of rendered images from a 3D model and the images obtained from a camera containing the object in a scene is alleviated or compensated without substantial degradation of data necessary to effectively train for object detection. Domain adaptation techniques such as the use of random or algorithmically chosen textures (e.g., noise, certain lighting conditions), and certain enhancement filters are adapted. “Algorithmically” can include “pseudo-randomly” herein. In other words, domain adaptation can be achieved by desensitizing the algorithm to texture during training, and/or using view classification, as described further below.

FIG. 6 illustrates a method 600 using the algorithm model to detect a location and/or pose of an object. First, the algorithm model is trained as provided in the method 500 of FIG. 5.

Then, in step 602, a camera (e.g., camera 60) acquires an input image containing an object in a scene. The enhancement filter (e.g., edge-enhancement filter) is applied to the acquired image, using the process discussed above for step 510, and the image patches from the filtered image are extracted using the process discussed above for step 512.

At this point, the system has extracted patches of the acquired, enhanced image and will determine a position of the object in the image by applying the trained algorithm model to the image patches. These extracted patches are compared with the patches stored from step 524 using random forest. Indeed, all overlapping patches are extracted and classified as object or background by the random forest. Patches classified as object vote for the object's center using the offsets stored in their corresponding leaves. The largest voted regions denote probable object location that can further be used by any pose refinement algorithm.

Subsequently, the pose of the object is derived. This is done by deriving 2D points by using a trained algorithm model with the image containing the object as input, the 2D points representing 2D projections of 3D points on the 3D bounding box defined around a 3D model, the 3D model corresponding to the object (S802). Then, the pose of the object is determined based on the 2D points and corresponding 3D points on the bounding box (S804) using a PnP algorithm. Note that the derived 2D points may be used as control points and/or keypoints for the PnP algorithm. The orientation, size, and location of the object or bounding box can quickly be determined, because of the limited number of 2D points (e.g. 8 or 9).

The fundamental differences between the algorithm of the present disclosure and previously known template matching algorithms makes the disclosed present method much more suitable for rough detection of an object's location on image from training with synthetic images. Even if some internal edges and contours remain missing and new unknown edges are generated locally, any correctly classified patches reliably and collectively vote for the object's location. In comparison, for previous template matching techniques, if part of the template edges is missing from the test image, the detection confidence reduces significantly.

The above mentioned logic makes the proposed method more robust for auto-training compared to previous type template matching based detectors. However, the present method can guide previous methods with its initial detection to help these previous methods reliably find candidates in restricted region-of-interest.

The various embodiments described herein provide a system for auto-training an object detection algorithm using synthetic images. The embodiments reduce the amount of user involvement in training the algorithm, remove the time and effort needed to capture multiple images of an actual object using each particular AR device to be trained to detect the object, and remove the need to have an actual copy of the object and the AR device to be trained.

Some embodiments provide a non-transitory storage medium (e.g. ROM 121, RAM 122, identification target storage section 139, etc.) containing program instructions that, when executed by a computer processor (e.g. CPU 140, processor 167, CPU 301), perform the methods described herein.

Although the invention has been described with reference to embodiments herein, those embodiments do not limit the scope of the invention. Modifications to those embodiments or different embodiments may fall within the scope of the invention.

What is claimed is:

1. A non-transitory computer readable medium that embodies instructions that cause one or more processors to perform a method comprising;
(a) generating a first image containing a model image based on a 3D model at a pose, the 3D model corresponding to an object,
(b) acquiring second images containing an image that does not contain the model image,
(c) extracting training image patches from the first image and the second images, each training image patch being associated with a class representing whether the corresponding image patch contains at least a part of the model image,
(d) training an algorithm model with the training image patches and the respective classes so as to derive a position of the model image with respect to the first image, and
(e) storing, in a memory, parameters defining the trained algorithm model.

2. A non-transitory computer readable medium according to claim 1,
wherein (a) generating the first image includes:
(a1) generating a domain-adapted image as the first image.

3. A non-transitory computer readable medium according to claim 2,
wherein (a1) generating the domain-adapted image as the first image includes:
(a11) providing the 3D model with information representing randomly or algorithmically chosen or generated texture, and
(a12) projecting the 3D model to obtain the domain-adapted image.

4. A non-transitory computer readable medium according to claim 2,
wherein (a1) generating the domain-adapted image includes:
(a13) rendering the 3D model to obtain a pre-image; and
(a14) applying an enhancement filter to the pre-image to obtain the domain-adapted image.

5. A non-transitory computer readable medium according to claim 1,
wherein the method further comprises;
applying an enhancement filter to the first image and the second images before (c) extracting the image patches from the first image and the second images.

6. The non-transitory computer readable medium according to claim 1, wherein the method further comprises:
(g) performing from (a) to (e) with respect to a predetermined pose range including the pose.

7. A non-transitory computer readable medium that embodies instructions that cause one or more processors to perform a method comprising;
(a) generating a domain-adapted image containing a model image based on a 3D model at a pose, the 3D model corresponding to an object,
(b) extracting training image patches from the domain-adapted image, each training image patch being associated with a class representing whether the corresponding image patch contains at least a part of the model image,
(c) training an algorithm model with the training image patches and the respective classes so as to derive a position of the model image with respect to the first image, and
(d) storing, in a memory, parameters defining the trained algorithm model.

8. The non-transitory computer readable medium according to claim 7,
wherein (a) generating the domain-adapted image includes:
(a1) providing the 3D model with information representing randomly or algorithmically chosen or generated texture, and
(a2) projecting the 3D model to obtain the domain-adapted image.

9. A non-transitory computer readable medium according to claim 7,
wherein (a) generating the domain-adapted image includes:
(a3) rendering the 3D model to obtain a pre-image
(a4) applying an enhancement filter to the pre-image to obtain the domain-adapted image.

10. The non-transitory computer readable medium according to claim 7, wherein the method further comprises:
(g) performing from (a) to (d) with respect to a predetermined pose range including the pose.

11. A non-transitory computer readable medium that embodies instructions that cause one or more processors to perform a method, the method comprising;
(a) acquiring, from a camera, an input image containing an object in a scene,
(b) applying an enhancement filter to the acquired input image,
(c) extracting image patches from the filtered input image,
(d) determining a position of the object in the input image by applying a trained algorithm model to the image patches,
wherein the trained algorithm model is trained with training image patches and respective classes so as to derive a position of a model image with respect to a first image, the model image being based on a 3D model at a pose, the 3D model corresponding to the object, and
wherein the training image patches are extracted from the first image and second images, the first image containing the model image, the second images containing no model image.

12. A non-transitory computer readable medium according to claim 11, wherein the method is further comprising;
(e) estimating a pose of the object based on the position of the model image in the image.

13. A non-transitory computer readable medium that embodies instructions that cause one or more processors to perform a method, the method comprising;
(a) acquiring, from a camera, an input image containing an object in a scene,
(b) applying an enhancement filter to the acquired input image,
(c) extracting image patches from the filtered input image,
(d) determining a position of the object in the input image by applying a trained algorithm model to the image patches,
wherein the trained algorithm model is trained with training image patches and respective classes so as to derive a position of a model image with respect to a first image, the model image being based on a 3D model at a pose, the 3D model corresponding to the object, and
wherein the training image patches are extracted from a domain-adapted image.

14. A non-transitory computer readable medium according to claim 13, wherein the method is further comprising;
(e) estimating a pose of the object based on the position of the model image in the image.
